(19) United States
(12) Patent Application Publication
(10) Pub. No.: US 2013/0185202 A1
(43) Pub. Date: Jul. 18, 2013

(54) SYSTEM AND METHOD FOR MOBILE PAYMENT TRANSACTIONS

(71) Applicant: VeriFone, Inc., San Jose, CA (US)

(72) Inventors: Scott GOLDTHWAITE, Hingham, MA (US); William GRAYLIN, Woburn, MA (US)

(73) Assignee: VERIFONE, INC., San Jose, CA (US)

(21) Appl. No.: 13/666,942

(22) Filed: Nov. 1, 2012

Related U.S. Application Data
(63) Continuation of application No. 10/625,823, filed on Jul. 23, 2003, now abandoned.
Application No. 10/625,823 is a continuation of application No. 13/305,625, filed on Nov. 28, 2011, now abandoned.

(51) Int. Cl. G06Q 20/34

(52) U.S. Cl. CPC G06Q 20/352
USPC 705/41; 705/44

(57) ABSTRACT

A system processes a request by a customer to pay a transaction amount, using the customer's account, for a transaction between the customer and a merchant, to provide a payment to an account of the merchant. The transaction incorporates use of a mobile wireless device operated by the customer to provide identification information of the customer's account to an authentication server. A payment server coupled to the authentication server and the merchant passes merchant communications to the authentication server. The authentication server receives the transaction amount from the merchant and receives customer account information from the customer's wireless mobile device, and processes the transaction and account information and, if authenticated, routes the payment transaction to the payment server for payment to the merchant's account.

### CROSS-REFERENCE TO RELATED APPLICATION

This application is a continuation of U.S. patent application Ser. Nos. 10/625,823, filed Jul. 23, 2003, entitled MOBILE DEVICE EQUIPPED WITH A CONTACTLESS SMART CARD READER/WRITER which claims priority to U.S. Provisional Patent Application Ser. No. 60/399,686, filed Jul. 30, 2002, and 13/305,625, filed Nov. 28, 2011, entitled SYSTEM AND METHOD FOR MOBILE PAYMENT TRANSACTIONS, each of which is incorporated by reference in their entirety.

### FIELD

The present invention relates to mobile devices, and more particularly to a mobile device that is equipped with a contactless smart card reader/writer for conducting financial transactions with a contactless smart card. The present invention also relates to a system and method for payment transaction authentication.

### BACKGROUND

The use of contactless smart cards, as defined in prior art U.S. Pat. No. 4,480,178, has experienced rapid growth particularly in the use of transit systems such as MiFare™ (developed by Phillips Semiconductors) and Octopus Cards (developed by Sony). These types of smart cards create a secure environment for storing monetary value while the contactless feature is fast and convenient for users who only need to bring the card in close proximity to a card reader. These types of contactless cards do not require a Personal Identification Number (PIN) and are therefore suited for high-volume, low value transactions. Users of the card can load value onto the card by using an Automated Teller Machine (ATM) or a kiosk to transfer money from a checking account, savings account, a credit card account or by inserting cash into the ATM. The user puts their ATM card or cash into the machine and positions a contactless card near the contactless reader/writer to complete the transfer of money. These ATMs are typically located at the entrance to the transit station where the customers purchase transit tokens. The popularity of contactless cards for transit has grown so that other vendors in area surrounding the transit system also accept the contactless card for payment for purchases such as parking, fast food, convenience stores and vending machines. Many merchants are installing contactless smart card reader/writers in their stores to provide the ability to accept contactless smart cards as a form of payment.

Because contactless smart card readers are required to load value onto a card and take value off of a card, the amount of readers in the marketplace is a key factor in determining the amount of usage of the contactless smart card.

The idea of adding a contactless reader/writer to a mobile phone is established in PCT WO 01/86599 A2, entitled “Smart Card Communications”. However, this prior art application specifies that the connection between the contactless reader/writer and the mobile phone is through “an interface connector such as those used for connecting to a regular data modem”. These types of interface connectors need to be customized for each type of mobile phone and the specific network that is connected to. Accordingly, there is a need for a universal connector that can be used in all types of mobile phones and all networks.

The general concept of a universal connector that can connect to any type of mobile phone and network is described in PCT patent application No. WO 99/66752, entitled “Communication Method and Apparatus Improvements”, the entire content of which is incorporated herein by reference. Referring to FIG. 2, this universal connector 200 connects to the mobile phone's existing Subscriber Identification module (SIM) slot 204 and utilizes a Central Processor Unit (CPU) 202 to coordinate the activities of multiple SIM cards 152, 156 and a full-size external smart card 153. This universal connector may be implemented as an attachment to a mobile phone or may be embedded in the mobile phone. Although this implementation includes several SIM cards and a card reader for regular contact type smart cards, it does not include a contactless smart card reader/writer. Accordingly, there is still a need for a universal contactless smart card reader/writer that can be attached to any phone and any network.

### SUMMARY

In general, in one aspect the invention features a wireless mobile device adapted to access a wireless network. The wireless mobile device includes a subscriber identification module (SIM) card slot and a contactless smart card module electrically connected to the SIM card slot and thereby to the wireless mobile phone. The contactless smart card module is adapted to receive and read information stored in a contactless smart card and transmit this information to an entity via the wireless mobile device and the wireless network.

Implementations of this aspect of the invention may include one or more of the following features. The contactless smart card module is further adapted to receive information from the entity via the wireless network and transmit and write this information in the contactless smart card. The information may include cardholder identification information, card identification information, authentication information, smart card issuer information, financial institution information, digital goods, digital services, or digital currency. The digital goods include electronic cash, electronic coupons, electronic gift certificates, electronic transit tokens, music, software, movies, and books. The wireless mobile device may further include a memory; a SIM card connected to the SIM card slot and authenticating the wireless mobile device to the wireless network, a Central Processing Unit (CPU) and a first application program associated with the memory and the CPU and being adapted to receive and transmit instructions from the contactless smart card module to the wireless mobile phone and the reverse. The wireless mobile device may further include a second application program associated with the memory and the CPU and being adapted to route and transmit data and information among the wireless mobile phone, the smart card module, and other interfaces connected to the CPU. These other interfaces may be smart card interfaces, infrared transceiver interfaces, serial communication interfaces, or magnetic stripe reader interfaces. The first and second application programs may be stored in the CPU, the SIM card, an external SIM card, the contactless smart card, or an external card. The wireless mobile device may also include an antenna for receiving and transmitting messages to and from the contactless smart card. The wireless mobile device may be a mobile phone, a personal digital assistant, a pager, a wireless laptop computer, a personal computer, a television remote control, and combinations thereof The wireless network may be a wireless wide area network (WWAN), a wireless local area network (WLAN), a private network, or a personal area network (PAN). The wireless wide area network (WWAN) may be a Global System for Mobile Communications (GSM), a Code Division Multiple Access (CDMA), CDMA 2000, or wideband CDMA (WCDMA). The wireless mobile device may be used for making financial transactions between a user and an entity with the contactless smart card over the network. The financial transactions between the user and the entity may be face-to-face or remote.

In general, in another aspect the invention features an electronic communication method including purchasing a good or a service from a merchant, and paying with a contactless smart card via a wireless mobile device. The wireless mobile device is adapted to access a wireless network and includes a subscriber identification module (SIM) card slot and a contactless smart card module electrically connected to the SIM card slot and thereby to the wireless mobile device. The contactless smart card module is adapted to receive and read information stored in the contactless smart card and transmit the information to an entity via wireless mobile device and the wireless network. Implementations of this aspect of the invention may include one or more of the following features. The electronic communication method may further include receiving the good or service electronically, storing it in the contactless card, retrieving the good or service from the contactless card and redeeming it.

In general, in another aspect the invention features an electronic payment method utilized by a customer to pay a merchant with electronic cash stored in a contactless smart card for a face-to-face purchase of a good or service. The method includes placing an order by the customer for the purchase of the good or service to the merchant and providing a wireless mobile device wherein the mobile device is adapted to access a wireless network and comprises a subscriber identification module (SIM) card slot and a contactless smart card module electrically connected to the SIM card slot and wherein the contactless smart card module is adapted to receive and read information stored in the contactless smart card and transmit the information via the wireless network. Next, entering information of the purchase in the wireless mobile phone, positioning the contactless smart card in close proximity to the wireless mobile device and retrieving smart card identification information and authorizing withdrawal of an electronic cash amount for payment for the good or service from the smart card. Next, sending the purchase information, the smart card identification information and the electronic cash amount to an authentication server via the wireless network, and authenticating and sending the purchase information and the electronic cash amount by the authentication server to a business account of the merchant held in a financial institution. Next, registering the purchase information and depositing the electronic cash amount to the merchant's business account and sending confirmation by the financial institution to the authentication server. Finally, forwarding the confirmation to the wireless mobile phone and fulfilling the order to the customer by the merchant.

In general, in yet another aspect the invention features an electronic payment method utilized by a customer to pay a merchant with a contactless smart card for a face-to-face purchase of a good or service. The method includes placing an order by the customer for the purchase of the good or service to the merchant and providing a wireless mobile device wherein the wireless mobile device is adapted to access a wireless network and comprises a subscriber identification module (SIM) card slot and a contactless smart card module electrically connected to the SIM card slot and wherein the contactless smart card module is adapted to receive and read information stored in the contactless smart card and transmit the information via the wireless network. Next, entering information of the purchase in the wireless mobile phone, positioning the contactless smart card in close proximity to the wireless mobile device, and retrieving smart card identification information from the contactless smart card and authorizing payment for the good or service. Next, formatting the purchase information, the smart card identification information and the payment authorization into a first message and sending the first message to an authentication server via the wireless network, and authenticating and sending the first message by the authentication server to a financial institution. Next, registering the purchase information and sending approval for the payment by the financial institution to the authentication server. Finally, forwarding the payment approval to the wireless mobile phone and fulfilling the order to the customer by the merchant.

In general, in yet another aspect the invention features an electronic payment method utilized by a customer to pay a merchant with a contactless smart card for a remote purchase of a good or service. The method includes placing an order by the customer for the purchase of the good or service to a merchant server via a first network and choosing to pay via a wireless mobile device wherein the wireless mobile device is adapted to access a wireless network and comprises a subscriber identification module (SIM) card slot and a contactless smart card module electrically connected to the SIM card slot and wherein the contactless smart card module is adapted to receive and read information stored in the contactless smart card and transmit the information via the wireless network. Next, providing the merchant server with an identification information for the wireless mobile device and creating a digital order comprising purchase information and the identification number for the wireless mobile device by the merchant server. Next, routing the digital order to an authentication server via the first network, formatting the digital order into a first message wherein the first message is adapted to be transmitted over the wireless network and routing the first message over the wireless network to the wireless mobile device. Next, displaying the first message on the wireless mobile device, and requesting and receiving authorization of payment from the customer via the wireless mobile device. Next, positioning the contactless smart card in close proximity to the wireless mobile device, retrieving smart card identification and security information, and formatting authorization result and smart card identification and security information into a second message and routing the second message to the authentication server. Next, authenticating and routing the second message to a financial institution, wherein the financial institution is the issuer of the contactless smart card. Finally, approving and executing the payment at the financial institution, forwarding the payment approval to the authentication server and from the authentication server to the wireless mobile phone and fulfilling the order to the customer by the merchant.

Implementations of this aspect of the invention may include one or more of the following features. The good or service may be a digital good or a digital service and the fulfilling includes downloading and storing the digital good or service in the contactless smart card. The digital good may be electronic cash, electronic coupons, electronic gift certificates, electronic transit tokens, music, software, movies, or books. The wireless mobile device may be a mobile phone, a personal digital assistant, a pager, a wireless laptop computer, a personal computer, a television remote control, or combinations thereof. The wireless network may be a wireless wide area network (WWAN), a wireless local area network (WLAN), a private network, or a personal area network (PAN). The wireless wide area network (WWAN) may be a Global System for Mobile Communications (GSM), a Code Division Multiple Access (CDMA), CDMA 2000, or wideband CDMA (WCDMA). The first and second messages may be formatted in Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), or proprietary message formats.

Among the advantages of this invention may be one or more of the following. Combining a contactless smart card reader with a wireless mobile device can dramatically increase the number of smart card reader points of sales (POS) in the marketplace. The increased number of POS offers convenience to consumers and more opportunities to merchants. Consumers with wireless mobile devices equipped with a smart card reader can load value to their contactless cards anytime and anywhere and may use their contactless smart cards for mobile commerce purchases with the mobile device such as ring tones, mobile airtime credits and other types of remote purchases. Merchants that do not have the ability to install a traditional contactless smart card reader/writer that requires power from an electrical outlet and integration with a cash register would also benefit from a mobile contactless reader/writer for many types of transactions. These merchants include taxi cabs, vending machines and “push cart” vendors. Additionally, a wireless mobile device equipped with a contactless smart card reader enables “peer-to-peer” transfer of money using contactless cards.

The invention defined in this application specifies that the contactless smart card module connects to the wireless mobile device through the Subscriber Identification Module (SIM) circuitry on a GSM mobile phone. This conFiguration allows the contactless smart card module to function as any other type of smart card module as specified in the GSM 11.14 communication standards and enables any GSM phone that supports GSM 11.14 to utilize the contactless smart card module. The advantage to this standards-based design enables any application to access the contactless smart card module using GSM 11.14 commands (i.e. Power On Card, Read Card) without having to make modifications to the mobile device itself. Although a mobile device may have many external interface points (i.e. serial, USB, Bluetooth, Infrared), these communication protocols, while standard, are implemented differently for each mobile device, therefore connecting a contactless smart card reader to any other interface point on the mobile device would require a specific interface application developed for each mobile device. Most mobile devices do not allow applications to be installed or modified on the device once the device has been distributed to customers. The advantage of the present invention is that the contactless smart card module can be used to retrofit any mobile device that does not allow reprogramming with or without the permission or knowledge of the mobile device manufacturer or the mobile network operator.

Another advantage of the present invention is the creation of many types of systems and methods for using contactless smart cards for purchasing and fulfillment of goods and services because of the network connectivity established by the connected mobile device. As was mentioned above, the present invention provides a POS system for mobile merchants (i.e. taxi cab drivers and fast food vendors) and allows them to accept contactless smart cards as a form of payment. The present invention also enables consumers to make remote purchases using contactless smart cards as a method of payment. Finally, the present invention provides consumers with the ability to purchase and download digital goods such as coupons, transit coupons and electronic cash (e-Cash) to a contactless smart card.

In general, in one aspect, the invention features an electronic payment system utilized by a customer to pay for the purchase of a good and/or a service with a payment card. The payment system includes a merchant server, a payment server, an authentication server and a communication device. The merchant server is in connection with a first network, and is adapted to receive a purchase order by the customer for the purchase of the good and/or service and to create a digital order including purchase order information. The payment server is also in connection with the first network, and is adapted to receive the digital order from the merchant server over the first network and to further route the digital order. The authentication server is in connection with the first network, and is adapted to receive the digital order from the payment server over the first network, format the digital order into a first message and route the first message over a second network. The communication device includes identification information of the payment card, and is adapted to receive the first message from the authentication server over the second network, display the first message to the customer, request and receive authorization for payment from the customer, retrieve payment card identification information, request and receive payment card security information from the customer, and route the authorization result and in case of a positive authorization result the payment card identification and security information to the authentication server over the second network. The authorization result and payment card identification and security information are routed from the authentication server to the payment server over the first network and from the payment server to a financial institution over the first network system. The financial institution is the issuer of the payment card and is asked to approve and execute the requested payment and to route the payment approval result through the payment server to the merchant server and to the authentication server.

Implementations of this aspect of the invention may include one or more of the following features. The authentication server may further route the payment approval result to the communication device. The merchant server may be further adapted to receive identification information for the communication device and the authentication server may be adapted to access the communication device via the communication device identification information over the second network. The communication device may further include an authentication client application. The authentication client application includes instructions for receiving the first message from the authentication server over the second network, displaying the first message to the customer, requesting and receiving authorization for payment for the purchase order with the payment card from the customer, retrieving payment card identification number, requesting and receiving payment card security information from the customer, routing the authorization result and in case of a positive authorization result the payment card identification and security information to the authentication server over the second network, and receiving the payment approval result and creating a record. The merchant server upon receiving a positive approval result may fulfill the purchase order. The authentication server may include an authentication server application. The authentication server application includes instructions for receiving the digital order from the payment server over the first network, formatting the digital order into a first message, routing the first message over a second network to the communication device, receiving the authorization result and payment card identification and security information from the communication device, routing the authorization result and payment card identification and security information to the payment server, receiving the payment approval result from the payment server, formatting the payment approval result into a second message and routing the second message to the communication device. The communication device may be a mobile wireless device and the second network may be a wireless network. The mobile wireless device may be a mobile phone, a personal digital assistant, a pager, a wireless laptop computer, a personal computer, a television remote control, or combinations thereof. The second network may be a wireless wide area network (WWAN), a wireless local area network (WLAN) or a wireless personal area network (PAN). The communication device may also be a wired communication device and the second network may be a wired network. The wired communication device may be a telephone or a computer and the wired network may be a telecommunications network or the Internet, respectively. The first network may be the Internet or a telecommunication network. The communication device may include identification information for a plurality of payment cards issued by a plurality of financial institutions. The communication device may include a first Subscriber Identification Module (SIM) card and the first SIM card may be adapted to store communication device and subscriber information. The first SIM card may be adapted to further store the payment card identification information and/or the authentication client application. The communication device may further include a second SIM card, and the second SIM card may be adapted to store the payment card identification information and/or the authentication client application. The communication device may further include an attachment adapted to receive an external payment card and route the external payment card identification information through the communication device to the authentication server. The first or second SIM cards may be Universal Subscriber Identification Module (USIM) cards that can support third generation (3G) network requirements. The payment card may be a credit card, a debit card, a stored-value card, a coupon card, a reward card, an electronic cash card, loyalty card, or an identification card. The merchant may receive the purchase order via the Internet, telephone connection, mail order form, fax, e-mail, voice recognition system, short message service, interactive voice recording (IVR), or face-to-face interaction with the customer. The purchase order information may include at least one of price, currency indicator, product identification, product description, quantity, delivery method, delivery date, shipping and billing information, merchant identification, payment method, communication device identification information, and transaction number. The format for the first message may be Short Message Service (SMS), General Packet Radio Service (GPRS), Transmission Control Protocol/Internet Protocol (TCP/IP), User Datagram Protocol (UPD), Simple Mail Transmission Protocol (SMTP), Simple Network Management Protocol (SNMP), or a proprietary message format. The identification information of the payment card may include at least one of payment card number, payment card expiration date, cardholder's name, cardholder's contact information, cardholder's account information, issuer financial institution identification, issuer financial institution contact information, and security information for the authentication of the cardholder. The security information may include at least one of a personal identification number (PIN), password, biometric signal, fingerprint, retinal scan, voice signal, digital signature, and encrypted signature, username and password combinations, identity certificate such as X.509, public and private keys to support Public Key Infrastructure (PKI), a Universal Card Authentication Field (UCAF), or combinations thereof. The security information of the payment card may be entered by the customer via the communication device.

In general, in another aspect, the invention features an electronic payment system utilized by a customer to pay for the purchase of a good and/or a service with a payment card. The payment system includes a merchant server, an authentication server, and a communication device. The merchant server is in connection with a first network, and is adapted to receive a purchase order by the customer for the purchase of the good and/or service and to create a digital order comprising purchase order information. The authentication server is in connection with the first network, and is adapted to receive the digital order from the merchant server over the first network, format the digital order into a first message and route the first message over a second network. The communication device includes identification information of the payment card, and is adapted to receive the first message from the authentication server over the second network, display the first message to the customer, request and receive authorization for payment for the purchase order with the payment card from the customer, retrieve payment card identification information, request and receive payment card security information from the customer, and route the authorization result and in case of a positive authorization result the payment card identification and security information to the authentication server over the second network. The authorization result and payment card identification and security information are routed from the authentication server to the financial institution over the first network system. The financial institution is the issuer of the payment card and is asked to approve and execute the requested payment and to route the payment approval result through the authentication server to the merchant server and to the communication device.

In general, in another aspect, the invention features an electronic payment system utilized by a customer to pay for a purchase of a good and/or a service with a payment card. The payment system includes a merchant server, a financial institution authentication server and a communication device. The merchant server is in connection with a first network, and is adapted to receive a purchase order by the customer for the purchase of the good and/or service and to create a digital order comprising purchase order information. The financial institution authentication server is in connection with the first network, and is adapted to receive the digital order from the merchant server over the first network, format the digital order into a first message and route the first message over a second network. The communication device includes identification information of the payment card, and is adapted to receive the first message from the financial institution authentication server over the second network, display the first message to the customer, request and receive authorization for payment for the purchase order with the payment card from the customer, retrieve payment card identification information, request and receive payment card security information from the customer, and route the authorization result and in case of a positive authorization result the payment card identification and security information to the financial institution authentication server over the second network. The financial institution authentication server is asked to approve and execute the requested payment and to route the approval result to the merchant server and to the communication device.

Among the advantages of this invention may be one or more of the following. From the customer's viewpoint, the process is similar to that of using a smart card or credit card with a merchant's Point Of Sale (POS) device or a bank's Automated Teller Machine (ATM). The invention has the advantage that the customer is using a personal, trusted mobile communication device to interact remotely with an authentication system and a payment server. The invention may be used for both non-face-to-face and face-to-face transactions. The presence of the payment card and the identity of the cardholder are strongly authenticated. The embedded IC chip in the payment card cannot be easily counterfeited, as is the case with the magnetic strip payment cards. The signature of a cardholder can be easily forged. However, a security feature such as a digital encrypted signature, PIN, password or biometric signal is difficult to copy. The invention offers a CNP payment transaction with a Personal Point of Sale (PPOS™). The combination of a Personal POS with the strong authentication of a smart card offers a dramatic decrease in payment card fraud. It is a convenient method of payment and easy to use for both the customer and the merchant.

### BRIEF DESCRIPTION OF THE DRAWINGS

FIG. 1 illustrates a circuitry according to this invention for a contactless smart card reader/writer module that converts a Single-SIM GSM phone into a Dual-SIM/Dual-Slot GSM phone with a contactless smart card reader/writer.

FIG. 2 illustrates a prior art circuitry for a mobile device attachment that converts a Single-SIM GSM phone into a Dual-SIM/Dual-Slot GSM phone with an external card reader;

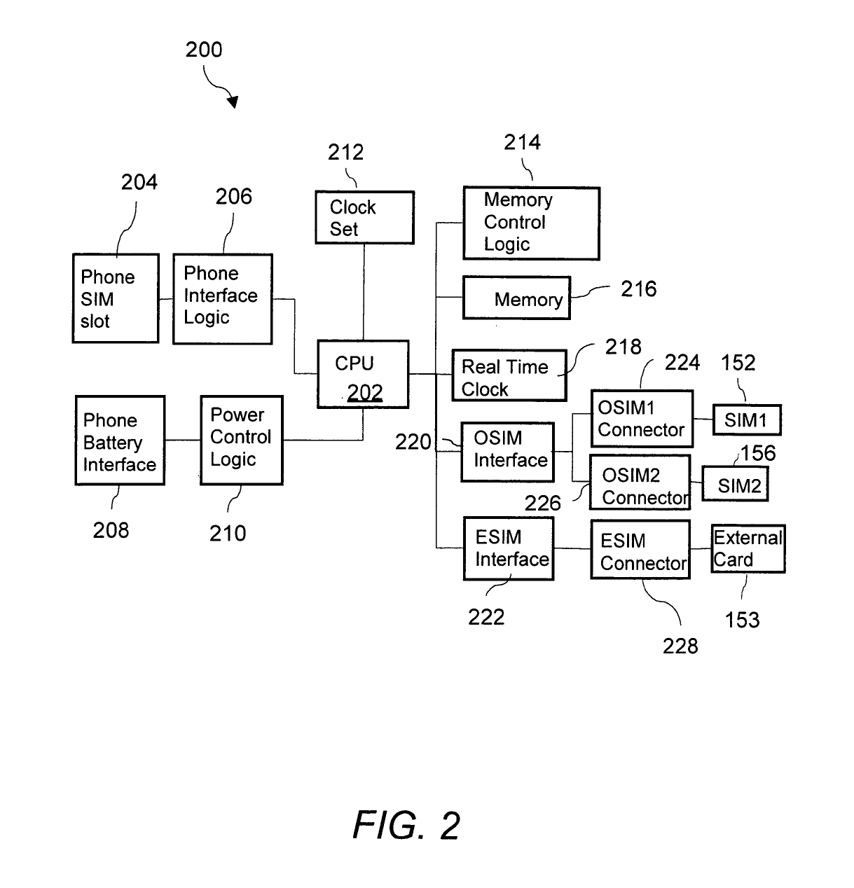

FIG. 3 illustrates a mobile phone with the contactless smart card reader/writer module of FIG. 1 and a contactless smart card.

FIG. 4 is a schematic diagram of a payment system utilizing the mobile phone of FIG. 3 for a face-to-face purchase according to an embodiment of this invention.

FIG. 5 is a schematic diagram of a payment system utilizing the mobile phone of FIG. 3 for remote purchases according to an embodiment of this invention.

FIG. 6 is a flow diagram of the remote payment system of FIG. 4.

FIG. 7 is a schematic diagram of a payment system for digital goods purchase and fulfilment using the mobile device of FIG. 3; and

FIG. 8 is a flow diagram of the payment and digital goods fulfilment system of FIG. 7.

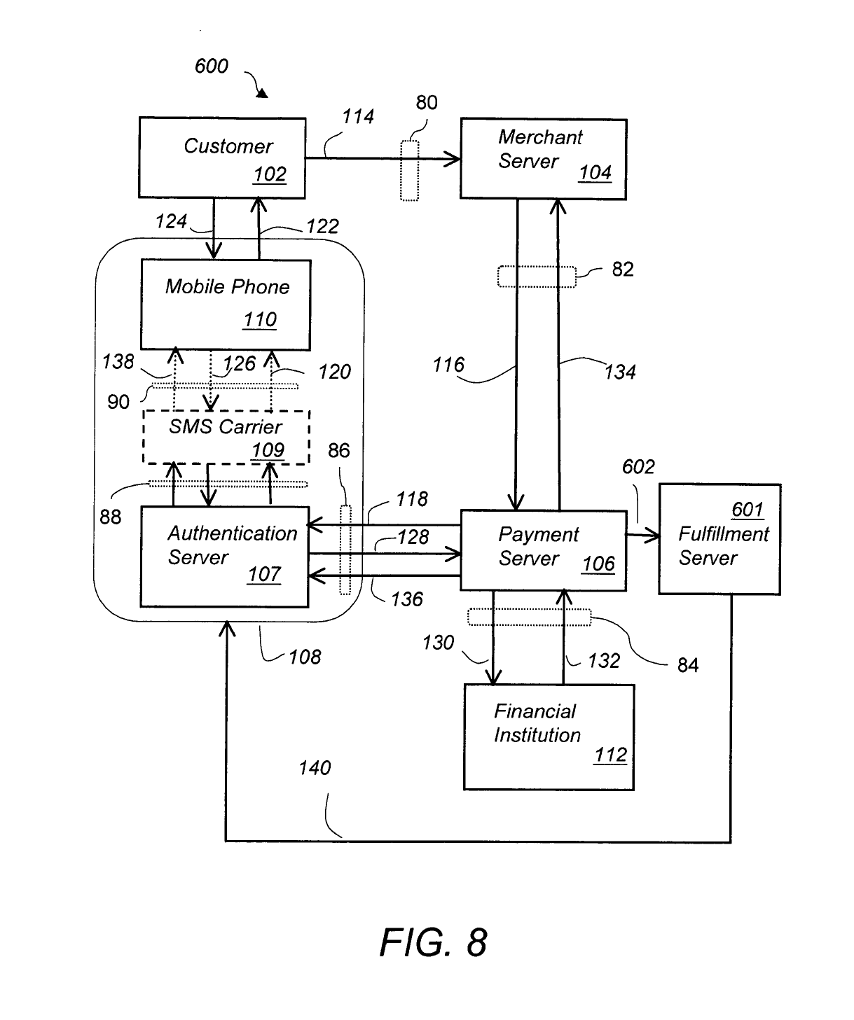

FIG. 9A is a schematic diagram of a payment system according to an embodiment of this invention.

FIG. 9B is a flow diagram of a payment system according to an embodiment of this invention.

FIG. 9C is a flow diagram of another embodiment of the payment system according to an embodiment of this invention.

FIG. 9D is a flow diagram of yet another embodiment of the payment system according to an embodiment of this invention.

FIG. 9E is a diagrammatic view of the system architecture for a mobile payment authorization system according to an embodiment of this invention.

FIG. 9F is a flow diagram of an authentication server application.

FIG. 9G is flow diagram of an authentication client application.

FIG. 9H is a flow diagram for a mobile payment authorization and authentication process.

### DETAILED DESCRIPTION

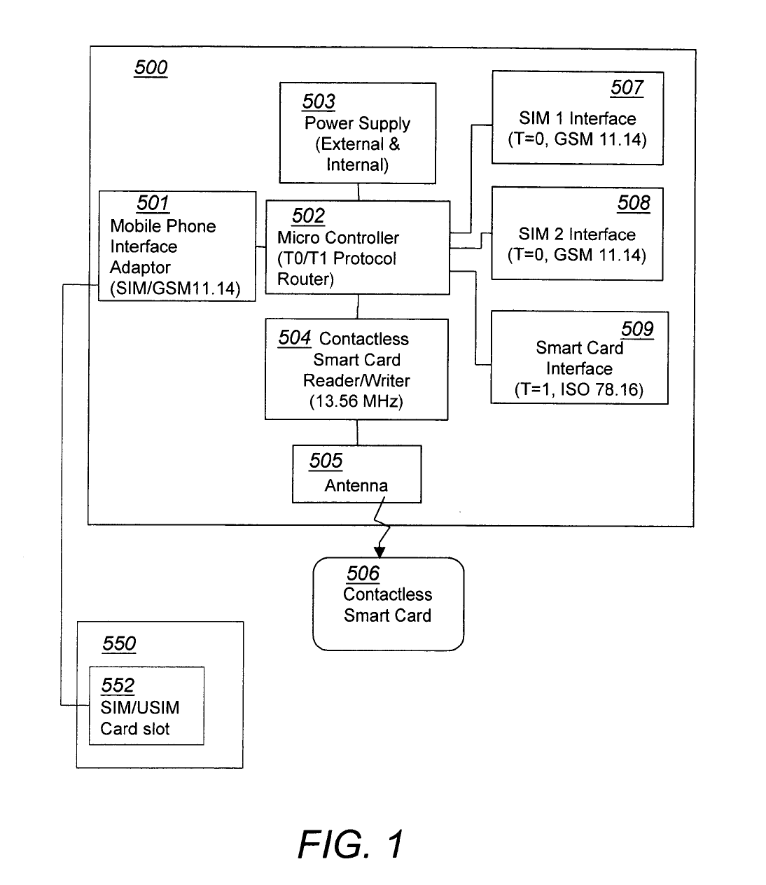

Referring to FIG. 1, a contactless smart card reader/writer module 500 is connected to a wireless mobile phone 550 through a Subscriber Identification Module/Universal/Subscriber Identification Module (SIM/USIM) card slot 552. The contactless smart card reader/writer module 500 includes a mobile phone interface adaptor (501) that connects to the Subscriber Identification Module/Universal Subscriber Identification Module (SIM/USIM) card slot circuitry 552 of the wireless mobile phone 550. In one example, the mobile phone interface adaptor 501 is described in WO 99/66752 application and U.S. Pat. No. 6,292,561 patent. The entire content of WO 99/66752 application and U.S. Pat. No. 6,292,561 patent is incorporated herein by reference. The contactless smart card reader/writer module 500 further includes a Micro Controller or Central Processing Unit (CPU) 502 that controls the mobile phone interface adaptor 501 and manages the routing of communications and controls between the mobile phone 550 and the contactless smart card reader/writer 504 as well as a plurality of smart cards. In addition to the contactless smart card reader/writer 504, module 500 includes a memory (not shown), SIM card interfaces 507, 508, adapted to receive SIM cards, and a smart card interface 509 that accepts regular contact-type smart cards. The CPU 502 receives commands from the mobile phone 550, analyzes the commands and routes those commands to the appropriate interface. The contactless smart card reader/writer 504 is connected to an antenna 505 that is mounted externally to the module or is embedded into the module's Printed Circuit Board (PCB). In other embodiments the antenna 505 is connected directly to the mobile phone 550. The contactless smart card reader/writer 504 receives activation commands and instructions via the CPU 502 from an application on any of the interfaces connected to the CPU 502, including an application on the mobile device interface 501, an application on the mobile phone 550, an application on the SIM Interface 507, an application on the SIM Interface 508, an application on the smart card Interface 509 or an application on the CPU itself. Using the antenna 505, module 500 receives and transmits information to and from a contactless smart card 506 using standard communication protocols as specified by ISO 14443 A/B and ISO 15693 standards using 13.56 MHz and 125 kHz frequencies. Module 500 is powered by a power supply 503 which may be either internal to the module or external.

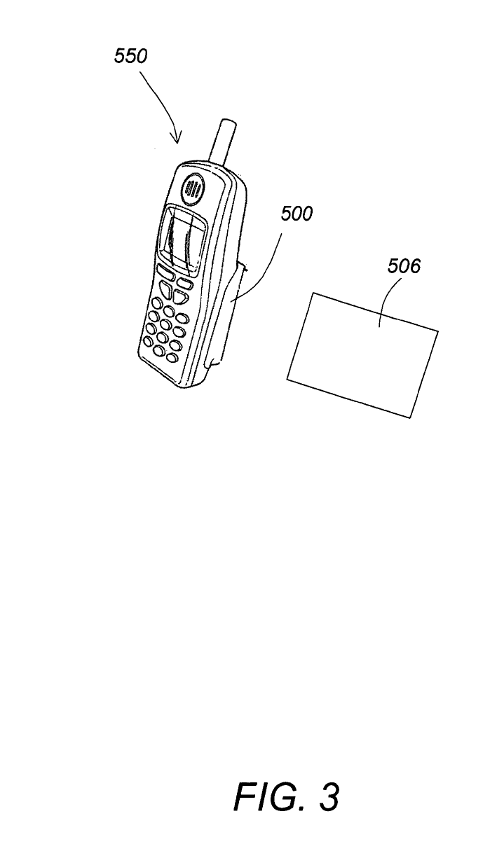

Referring to FIG. 3, for existing mobile phones, the module 500 is an attachment that connects to the existing SIM slot on the mobile phone 550. The module 500 may also be embedded within the mobile device. In either case, the mobile phone 550 receives and transmits information to and from a contactless smart card 506 when the contactless card 506 is brought in close proximity to the mobile phone 550.

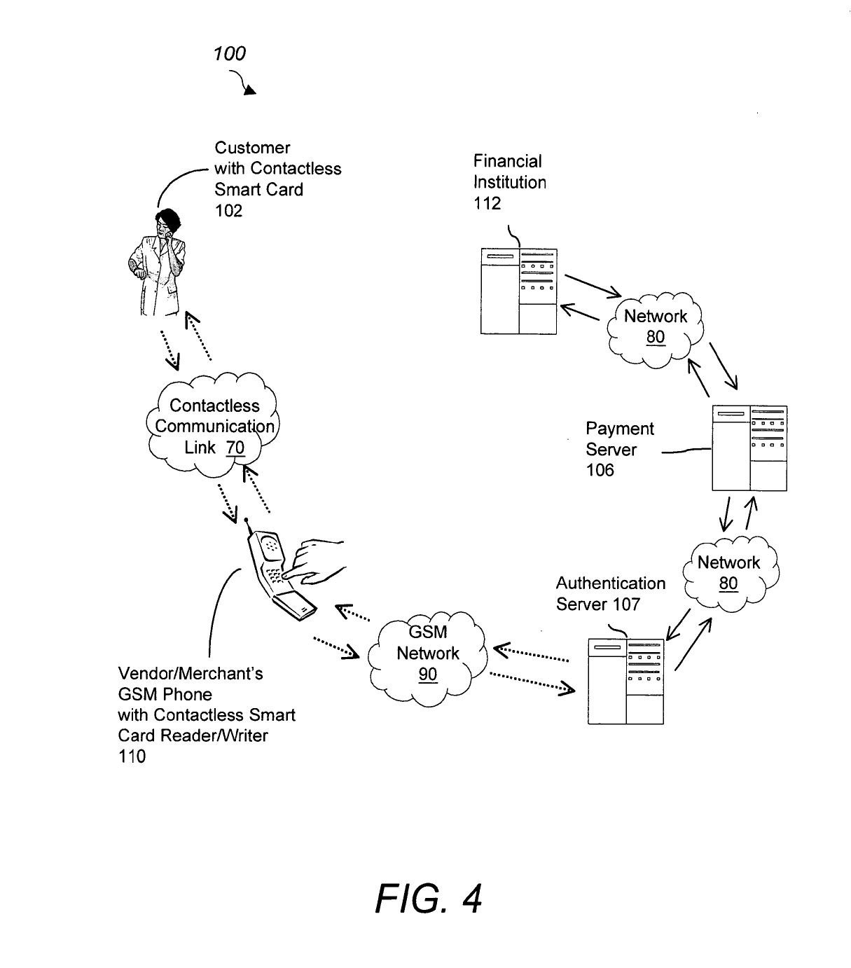

One embodiment of the present invention provides a contactless smart card payment system where the user of the mobile phone equipped with a contactless smart card reader is able to accept contactless smart cards as a form of payment for face-to-face purchases. Referring to FIG. 4, a payment transaction system 100 for a face-to-face purchase of a product or a service includes a customer 102 with a contactless smart card, a merchant with a mobile device 110 equipped with a contactless smart card reader, a payment server 106, an authentication server 107, and a financial institution 112. The authentication server 107 receives and transmits messages in a short message service (SMS) format to the merchant's mobile phone 110 via an SMS carrier through a wireless Global System for Mobile Communication (GSM) network 90. The mobile phone 110 receives and transmits information from and to a contactless smart card. After completing the purchase of a product or a service with the merchant, the customer 102 provides the merchant with the contactless smart card to pay for the purchase. The merchant activates a mobile payment application on the mobile device 110 and positions the contactless smart card in close proximity to the mobile device. The contactless smart card reader activates the application on the contactless smart card using wireless smart cards communication protocol 70. Using the contactless reader on the mobile phone 110, the payment application on the mobile device sends the appropriate commands to the smart card to deduct from the smart card the amount for the purchase. The mobile phone 110 encrypts the transaction information and sends a message to the authentication server 107 over the wireless GSM network 90. The message includes the merchant vendor information, type of purchase and the amount due. The authentication server 107 validates the transaction information from the mobile device, decrypts the transaction information and routes the transaction information to the payment server 106 over communication network 80. The payment server 106 connects to the merchant's financial institution 112 over communication network 80. The financial institution 112 processes the payment, updates the merchant's account and sends a confirmation of the payment to the payment server 106. The payment server 106 routes the payment confirmation to the authentication server 107. The authentication server 107 encrypts and sends a message confirming the payment to the merchant's mobile device 110. In one example, the authentication server 107 is described in a co-pending patent application entitled “System and method for payment transaction authentication”, the entire content of which is incorporated herein by reference.

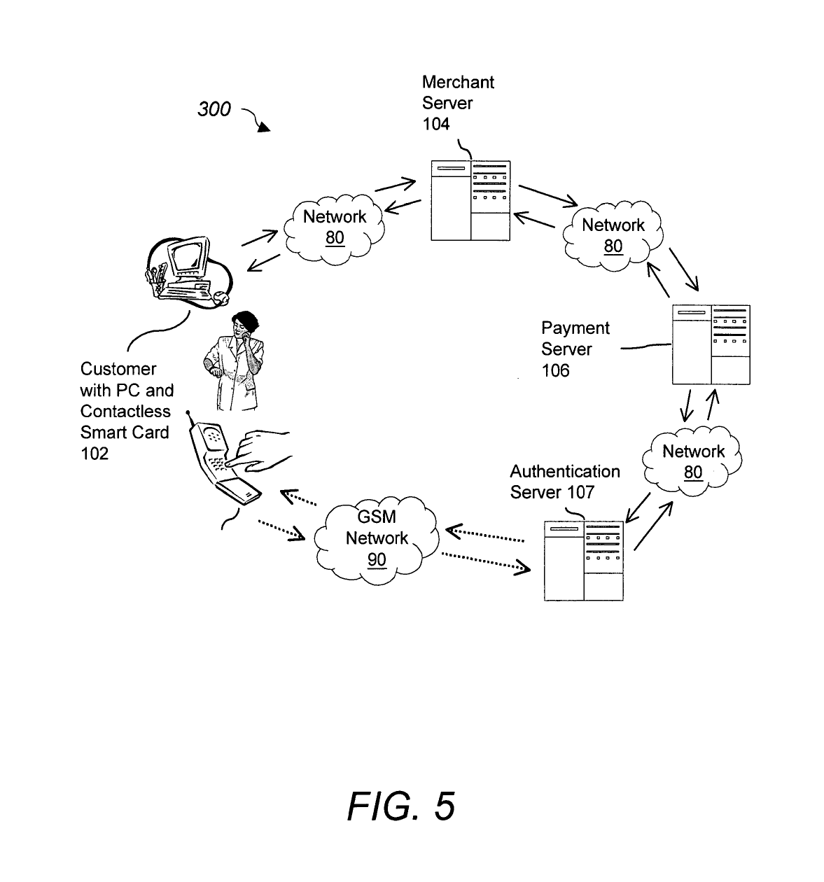

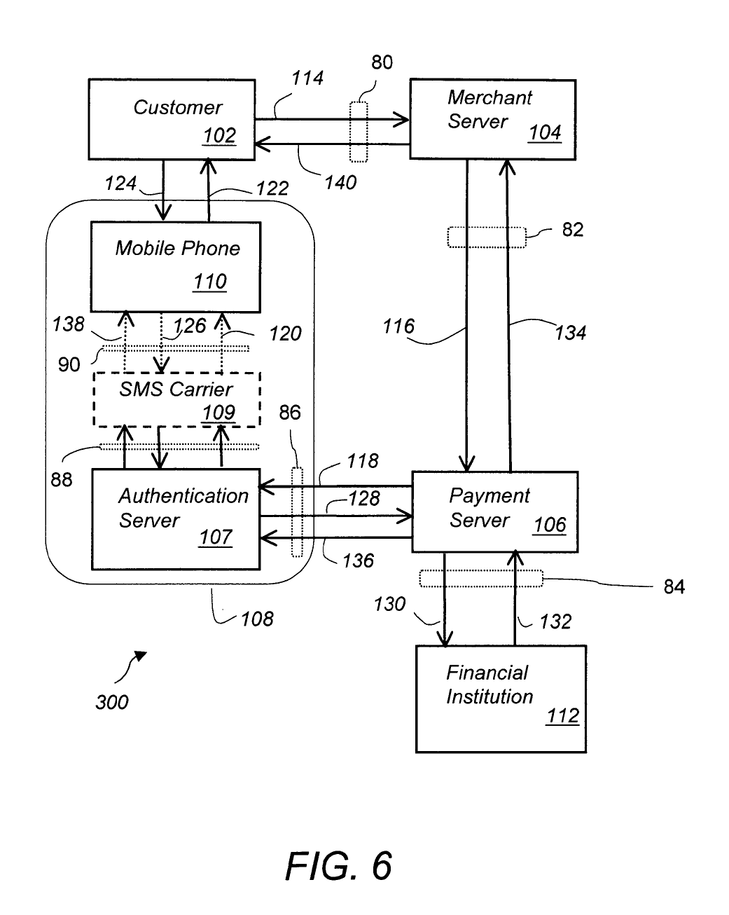

In another embodiment, the present invention provides a contactless smart card payment system for consumers making remote purchasing and payment transactions. Referring to FIG. 5 and FIG. 6, a payment transaction system 300 includes a customer 102, a merchant server 104, a payment server 106, an authentication system 108, and a financial institution 112. The authentication system 108 includes an authentication server 107 that is adapted to send and receive messages in a short message service (SMS) format to a mobile phone 110 via an SMS carrier 109. The mobile phone 110 is adapted to receive a contactless smart card (not shown). After having placed an order for an item or a service through a personal computer (PC) connected via the Internet 80 to the merchant server 104, a customer 102 is asked to choose a payment method. The customer 102 chooses to pay via her mobile phone 110 and gives her mobile phone identification information to the merchant server 104 (114). In one example, the mobile phone identification information is the mobile phone number. The merchant server 104 routes the customer's mobile phone number and information about the purchase order to a payment server 106 (116). The payment server 106 contacts the authentication server 107 and routes the customer's mobile phone number and information about the purchase (118). The authentication server 107 sends an SMS message to the customer's mobile phone 110 through an SMS carrier 109 (120). The customer 102 receives the SMS message asking her to authorize the purchase and choose a payment card (122). The customer 102 authorizes the purchase, positions the contactless smart card in proximity to her mobile phone 110, and enters a security code (if required) to pay and authenticate her purchase (124). In one example, the security code is a personal identification number (PIN). Other examples include a password, digital signature, and a biometric identifier, i.e., retina scan, fingerprint, DNA scan, voice characteristics. The payment card is identified with information that is embedded in the card. In one example the identification information is a payment card number. Other examples of payment card identification include an encrypted transaction signature that can only be decrypted by the financial institution that has issued the payment card, expiration date of the payment card, and a digital signature. In another example the payment card may contain an electronic purse (e-Purse) with stored value (i.e. e-Cash, e-Coupon, e-Ticket) contained within the smart card and the amount of the transaction is deducted from the e-Purse. The mobile phone 110 sends an SMS message via the SMS Carrier 109 to the authentication server 107. The SMS message includes the authorization result (if required) and payment transaction information. The authentication server 107 routes the authorized purchase order and authenticated card information to the payment server 106 (128). If the transaction is not a stored value smart card transaction, the payment server 106 contacts the financial institution 112 that has issued the payment card and routes the payment card information and the purchase order information (130). If the transaction is a stored value transaction, the payment server 106 contacts the financial institution of the merchant and routes the payment transaction information. The financial institution 112 processes the payment transaction and sends a confirmation of the payment transaction to the payment server 106 (132). The payment server 106 routes the payment confirmation to the merchant server 104 (134) and to authentication server 107 (136). The authentication server 107 sends an SMS message confirming the payment transaction to the customer's mobile phone 110 (138). Finally the merchant 104 fulfills the customer's purchase order (140).

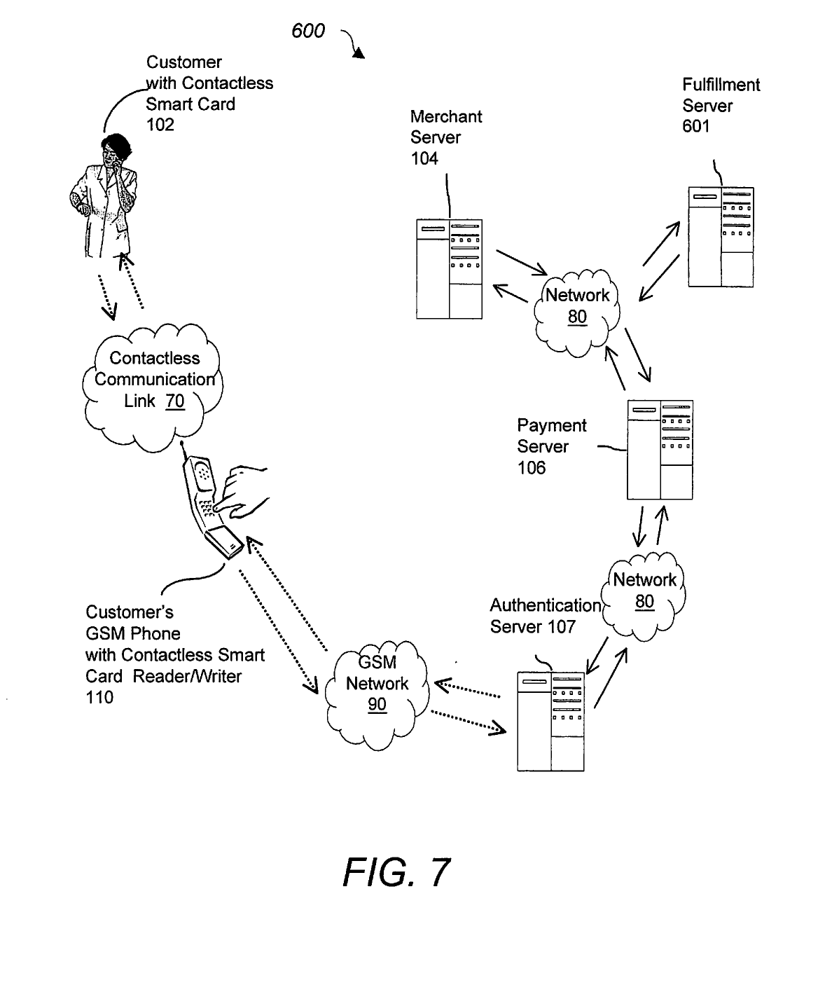

In another embodiment, the present invention provides a contactless smart card payment and digital goods fulfillment system. The contactless smart card has the ability to retain stored value or other types of information within the card. These “digital goods” are electronic, virtual information that represent value such as electronic cash (e-Cash), electronic coupons (e-Coupon), electronic tickets (e-Ticket), electronic transit tokens and digital media such as music, software, movies, books and other digital content. The payment transaction and digital goods fulfillment system allows the purchase of digital goods and reception and storage of the digital goods on the contactless smart card. Referring to FIG. 7 and FIG. 6, a payment transaction and digital goods fulfillment system 600 includes a customer 102 with a contactless smart card and a mobile device 110 equipped with contactless smart card reader/writer 110, a merchant server 104, a payment server 106, an authentication system 108, a financial institution 112 and a fulfilment server 601. The authentication system 108 includes an authentication server 107 that is adapted to send and receive messages in a short message service (SMS) format to a mobile phone 110 via an SMS carrier 109. The mobile phone 110 is adapted to receive the contactless smart payment card. After having placed an order for digital goods via the Internet, SMS, WAP or voice 80, a customer 102 is asked to choose a payment method. The customer 102 chooses to pay via her mobile phone 110 and gives her mobile phone identification information to the merchant server 104 (114). In one example, the mobile phone identification information is the mobile phone number. The merchant server 104 routes the customer's mobile phone number and information about the purchase order to a payment server 106 (116). The payment server 106 contacts the authentication server 107 and routes the customer's mobile phone number and information about the purchase (118). The authentication server 107 sends an SMS message to the customer's mobile phone 110 through an SMS carrier 109 (120). The customer 102 receives the SMS message asking her to authorize the purchase and choose a payment card (122). The customer 102 authorizes the purchase, uses a smart card that is associated with her mobile phone 110, and enters a security code to pay and authenticate her purchase (124). In one example, the security code is a personal identification number (PIN). Other examples include a password, digital signature, and a biometric identifier, i.e., retina scan, fingerprint, DNA scan, voice characteristics. The payment card is identified with information that is embedded in the card. In one example the identification information is a payment card number. Other examples of payment card identification include an encrypted transaction signature that can only be decrypted by the financial institution that has issued the payment card, expiration date of the payment card, and a digital signature. The mobile phone 110 sends an SMS message via the SMS Carrier 109 to the authentication server 107. The SMS message includes the authorization result and payment transaction information (126). The authentication server 107 routes the authorized purchase order and authenticated card to the payment server 106 (128). The payment server 106 contacts the financial institution 112 that has issued the payment card and routes the payment card information and the purchase order information (130). The financial institution 112 processes the payment transaction and sends a confirmation of the payment transaction to the payment server 106 (132). The payment server 106 routes the payment confirmation to the merchant server 104 (134), presents a digital receipt to the fulfillment server 601 (602) and routes the payment confirmation to the authentication server 107 (136). The authentication server 107 sends an SMS message confirming the payment transaction to the customer's mobile phone 110 (138). Finally the fulfillment server 601 fulfills the customer's order for digital goods (140) by sending the electronic information that represents the digital goods to the 10 authentication server 107. The authentication server 107 sends an SMS message to the customer's mobile phone 110 through an SMS carrier 109 (120). The mobile phone 110 receives the digital goods from the authentication server 107 and the customer 102 receives a message that digital goods are available for the contactless smart card. The customer 102 positions the contactless smart card in close proximity to the mobile phone 110 that is equipped with a contactless smart card reader/writer. The mobile phone 110 establishes a communication link 70 with the contactless smart card and transfers the digital goods to the contactless smart card.

Other embodiments are within the scope of the following claims. For example, the mobile phone identification information may be an Internet Protocol (IP) address. The communication networks 80, 82, 84, 86, 88 and 90 may be wireless or wired networks. The communication networks 80, 82, 84, 86, 88 and 90 may be non face-to-face via the Internet, VPN (Virtual Private Network), cable network, data network, telephone network, private voice and data networks, public voice and data networks, and mail or person to person. Payment card identification may occur via the payment card number or via an encrypted transaction signature that can only be decrypted by the financial institution that has issued the payment card. The authentication server may also utilize a password, digital signature, or a biometric identifier, i.e., retina scan, fingerprint, voice characteristics, to authenticate the payment transaction. The payment authentication instrument may be contained in the contactless smart card, on the SIM smart cards within the mobile phone 110, or within another full-size smart card that needs to be inserted into a smart card reader slot. The communication between the authentication server 107 and the mobile phone 110 may be via a proprietary message protocol that utilizes User Datagram Protocol (UDP) on top of Internet Protocol (IP). This proprietary message protocol is adapted to be used with wireless networks that support Transmission Control Protocol/Internet Protocol (TCP/IP). These wireless networks include Bluetooth, 3G, GPRS, 2.5G, Infrared, 802.11a and 802.11b.

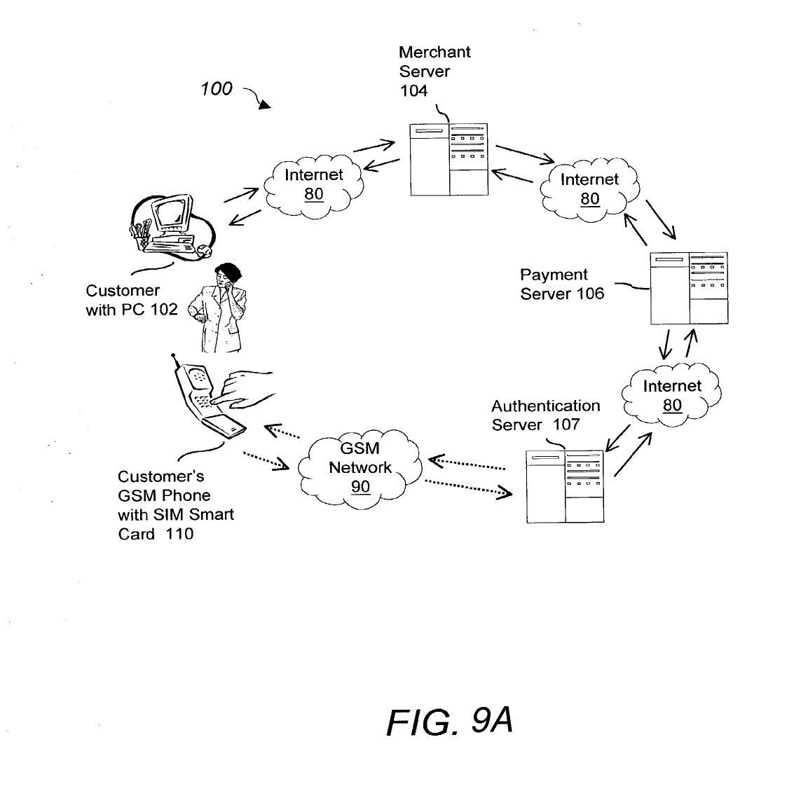

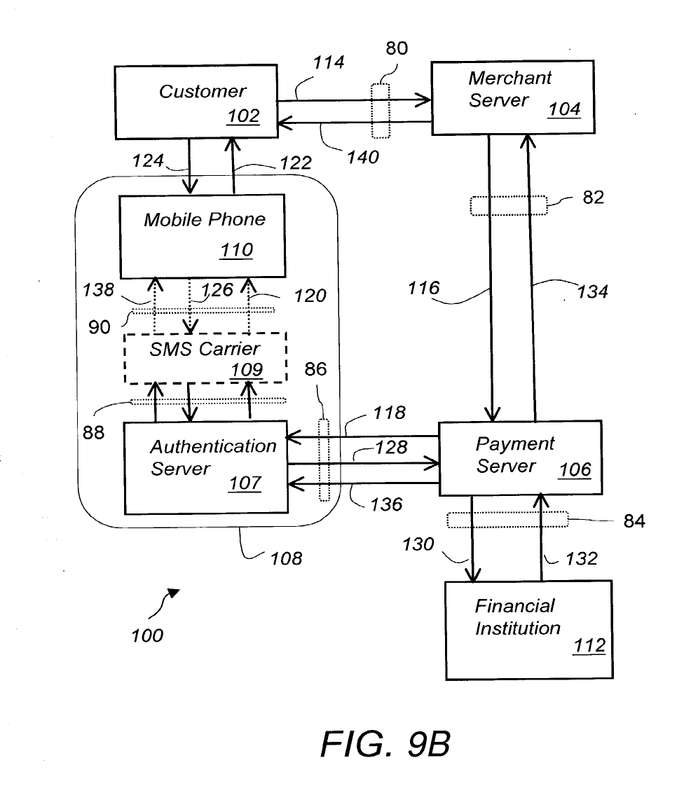

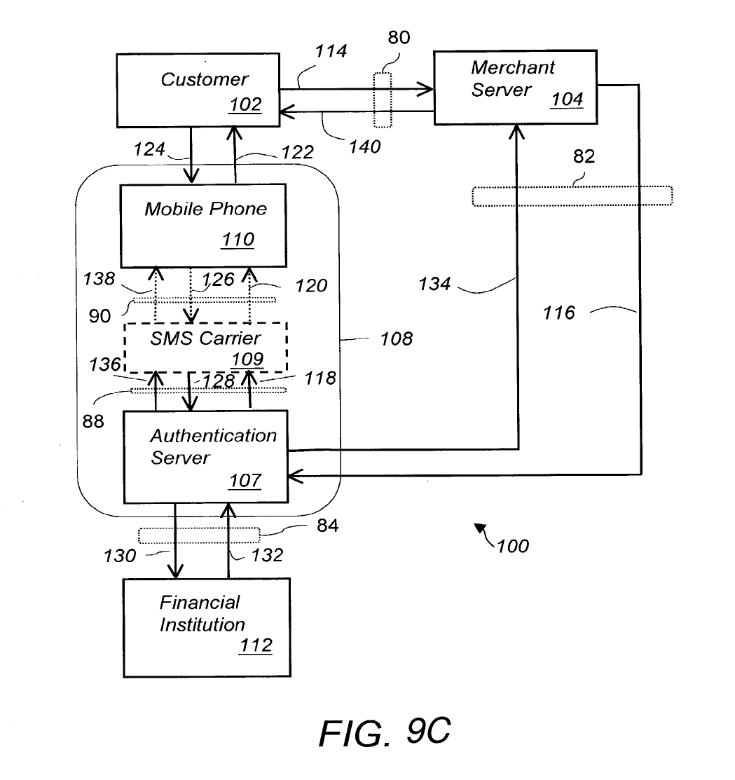

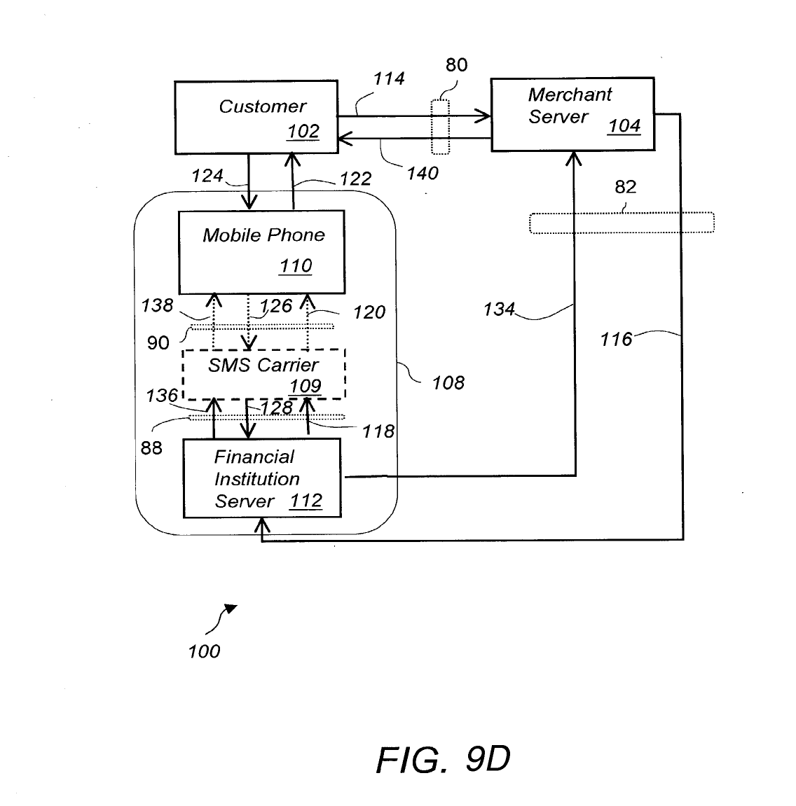

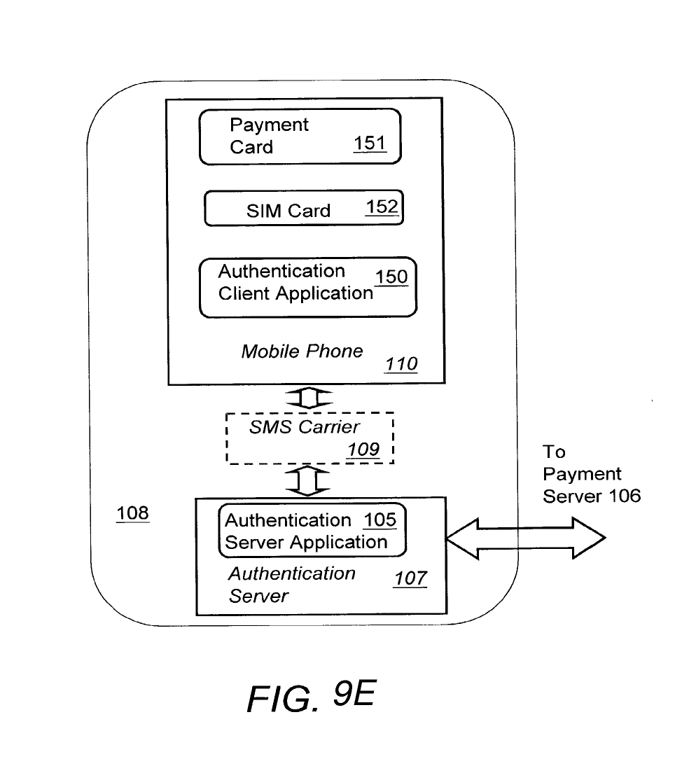

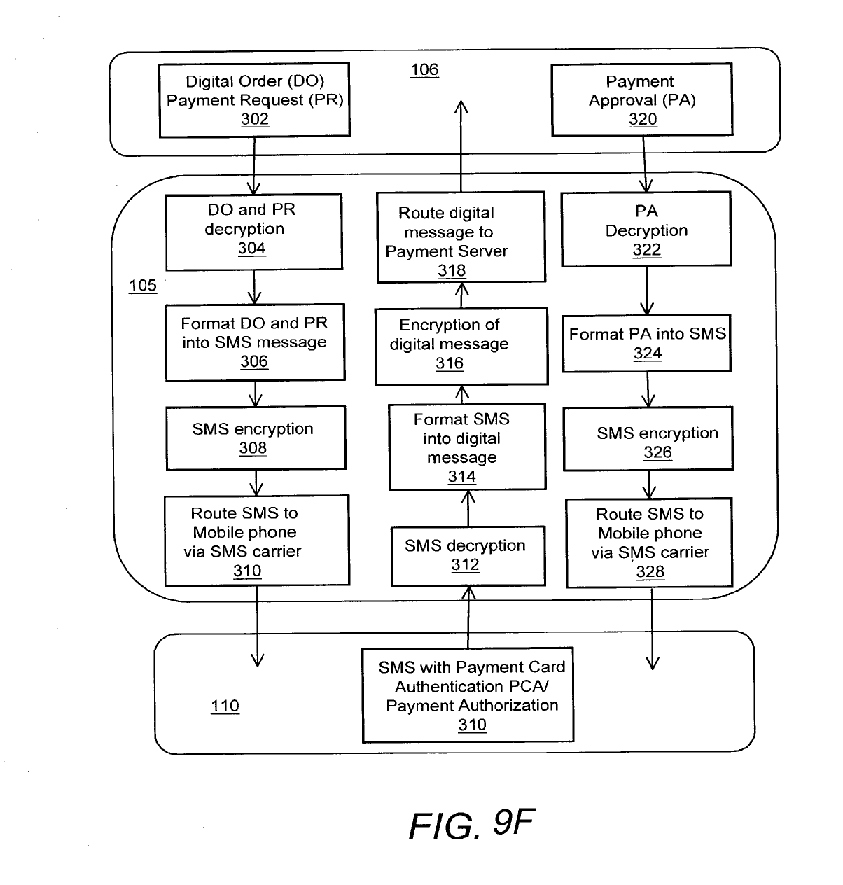

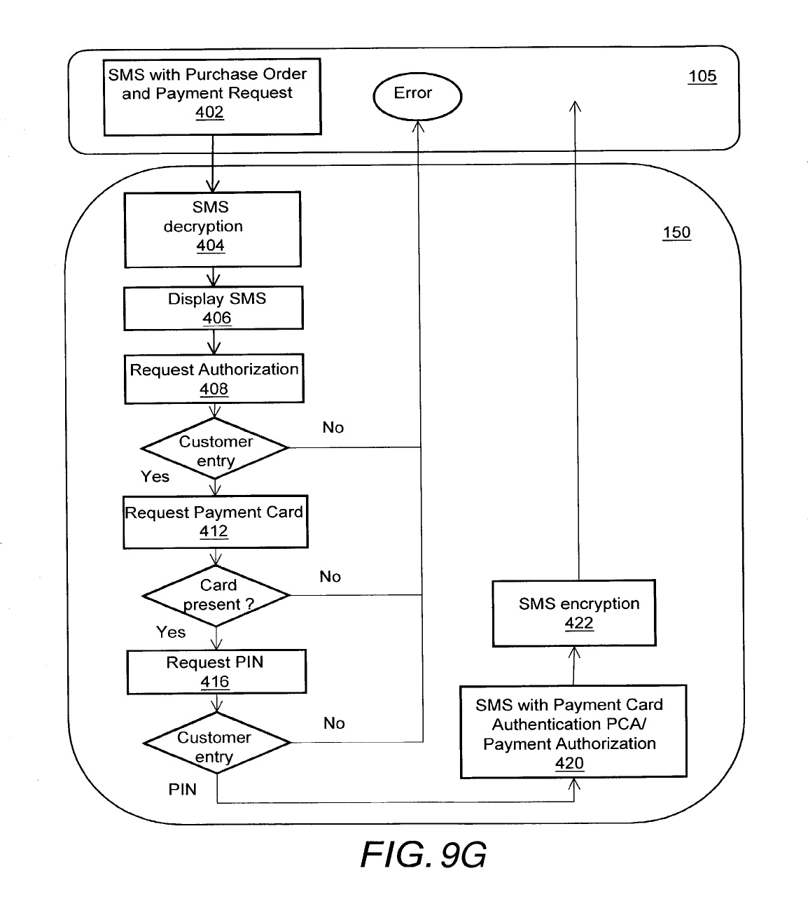

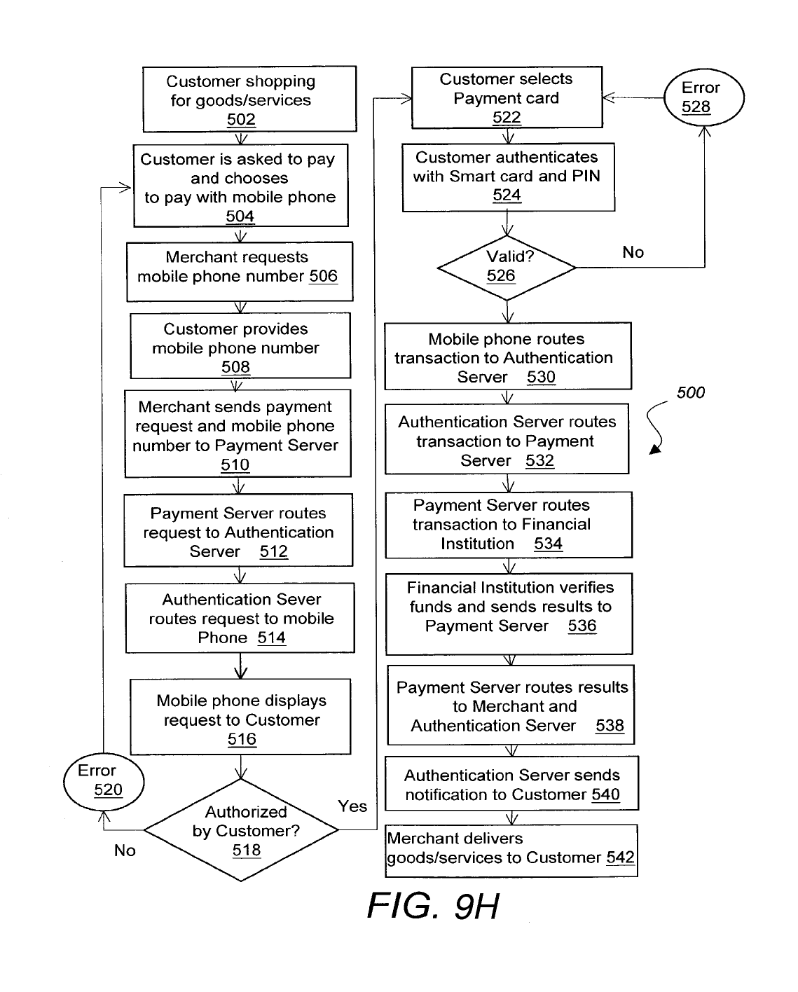

Referring to FIG. 9A and FIG. 9B, a payment transaction system 100 includes a customer 102, a merchant server 104, a payment server 106, an authentication system 108, and a financial institution 112. The authentication system 108 includes an authentication server 107 that is adapted to send and receive messages in a short message service (SMS) format to a mobile phone 110 via an SMS carrier 109. The mobile phone 110 is adapted to receive a payment card (shown in FIG. 3) or has a built-in payment card (not shown). After having placed an order for an item or a service via the Internet 80, a customer 102 is asked to choose a payment method. The customer 102 chooses to pay via her mobile phone 110 and gives her mobile phone identification information to the merchant server 104 (114). In one example, the mobile phone identification information is the mobile phone number. The merchant server 104 routes the customer's mobile phone number and information about the purchase order to a payment server 106 (116). The payment server 106 contacts the authentication server 107 and routes the customer's mobile phone number and information about the purchase (118). The authentication server 107 sends an SMS message to the customer's mobile phone 110 through an SMS carrier 109 (120). The customer 102 receives the SMS message asking her to authorize the purchase and choose a payment card (122). The customer 102 authorizes the purchase, uses a smart card that is associated with his mobile phone 110, and enters a security code to pay and authenticate his purchase (124). In one example, the security code is a personal identification number (PIN). Other examples include a password, digital signature, and a biometric identifier, i.e., retina scan, fingerprint, DNA scan, voice characteristics. The payment card is identified with information that is embedded in the card. In one example the identification information is a payment card number. Other examples of payment card identification include an encrypted transaction signature that can only be decrypted by the financial institution that has issued the payment card, expiration date of the payment card, and a digital signature. The mobile phone 110 sends an SMS message via the SMS Carrier 109 to the authentication server 107. The SMS message includes the authorization result, payment card identification and PIN information (126). The authentication server 107 routes the authorized purchase order and authenticated card to the payment server 106 (128). The payment server 106 contacts the financial institution 112 that has issued the payment card and routes the payment card information and the purchase order information (130). The financial institution 112 processes the payment transaction and sends a confirmation of the payment transaction to the payment server 106 (132). The payment server 106 routes the payment confirmation to the merchant server 104 (134) and to authentication server 107 (136). The authentication server 107 sends an SMS message confirming the payment transaction to the customer's mobile phone 110 (138). Finally the merchant 104 fulfills the customer's purchase order (140).

Merchant server 104 provides the presentation, offering and fulfillment of goods and services, as well as order processing, inventory and accounting functions. In one example, merchant server 104 is an Enterprise Resource Planning (ERP) system provided by companies such as SAP AG, (Neurottstrasse 16, 69190 Walldorf, Germany) or Oracle Corporation (500 Oracle Parkway, Redwood Shores, Calif. 94065). Another example of a merchant server 104 is a travel reservation system such as Saber provided by American Airlines (4333 Amon Carter Boulevard Fort Worth, Tex. 76155). Customer 102 interacts with the merchant server 104 through a “customer interface portal” (not shown). The customer 102 views the offered goods and services and places an order through the customer interface portal. The customer 102 may interact with the merchant server 104 via online or offline communication networks 80. These communication networks 80 include the Internet, the telephone, mail, and visiting a store. In one example, the customer interface portal is the Amazon.com website that is accessible via the Internet. Other examples of customer interface portals include an order form from a Lands End catalog, that can be filled out, mailed or faxed to the Lands End company, walking into a Wal-Mart store or calling American Airlines on the telephone to make a travel reservation. In the case of the mail order, the purchase order information is entered by a data entry person into the merchant server 104. In the case of a telephone order, the purchase order information is entered by a call center representative into the merchant server 104.

The merchant server 104 processes the payment transaction with the financial institutions 112 that have issued the payment cards, through the payment server 106. The payment server 106 is an application located on a server of a third party company. In one example, the payment server 106 is an application provided by companies including Payment (1601 Elm Street, Suite 900, Dallas, Tex. 75201), QSI Payments Inc. (Level 22, 300 Adelaide Street, Brisbane, Queensland 4000, Australia), and Mosaic Software (Culverdon House Abbots Way, Chertsey, Surrey KT169LE, United Kingdom).

The message routing 114, 140 occurs over communication network 80, message routing 116, 134, occurs over communication network 82, message routing 118, 128, 136 occurs over communication network 86, message routing 120, 122, 124, 126, 138, occurs over communication network 90, and message routing 130, 132, occurs over communication network 84. In one example, communication networks 80, 82, 84, 86, and 88 are the Internet and communication network 90 is a wireless network. The wireless network 90 may be a Wireless Wide Area Network (WWAN) (i.e., GSM, TDMA, CDMA, 3G, iDEN, Mobitex, and DataTac), a Wireless Local Area Network (WLAN) (i.e., 802.11a, 802.11b), or a Personal Area Network (PAN) (i.e., Bluetooth, Infrared). Other examples of communication networks 80, 82, 84, 86, 88 and 90 include private voice and data networks, and public voice and data networks. Message routing 114-140 is encrypted.

In the embodiment of FIG. 9C the operational functions of the payment server are integrated within the authentication server 107. In this embodiment the merchant server 104 routes the purchase order to the authentication server 107 (116). The authentication server 107 also communicates directly with the financial institution 112 (130) after having received authorization of the payment by the customer and authentication of the cardholder's identity and verification of the presence of the payment card (128). Finally the authentication server 107 receives the payment approval by the financial institution 112 (132) and routes the approval to the merchant server 104 (134) and to the mobile phone 110 (136).

In the embodiment of FIG. 9D the operational functions of the payment server and authentication server are integrated within the financial institution server 112. In this embodiment the merchant server 104 routes the purchase order to the financial institution server 112 (116). The financial institution server 112 communicates directly with the mobile phone 110 (118) in order to received authorization of the payment by the customer and authentication of the cardholder's identity and verification of the presence of the payment card. Finally the financial institution server 112 approves and executes the payment transaction and routes the approval to the merchant server 104 (134) and to the mobile phone 110 (136). In this embodiment the merchant purchase order further includes identification information of the financial institution 112.

Referring to FIG. 9E, the authentication system 108 includes an authentication server 107 that communicates with a mobile phone 110 via an SMS carrier 109. The authentication server 107 includes an authentication server application 105. The mobile phone 110 includes an authentication client application 150, a subscriber identity module (SIM) card 152 and a payment card 151.

Referring to FIG. 9F, the authentication server application 105 receives a digital purchase order and payment request message (302) from the payment server 106, performs message decryption (304), formats the digital order and payment request into an SMS message (306), performs SMS message encryption (308), and performs secure SMS routing to the mobile phone 110 via the SMS carrier 109 (310). The authentication server application 105 also receives an SMS message with payment card authentication and payment authorization (310) from the mobile device 110, performs SMS message decryption (312), formats SMS into a digital message (314), performs digital message encryption (316), and performs secure message routing to the payment server (318). Finally, the authentication server application 105 receives the payment approval message from the payment server (320), performs message decryption (322), formats the payment 15 approval message into an SMS message (324), performs SMS message encryption (326), and performs secure SMS routing to the mobile phone 110 via the SMS carrier 109 (328).

Referring to FIG. 9G, the authentication client application 150 receives an SMS message with purchase order information and payment request from the authentication server 107 (402), performs SMS message decryption (404), displays the SMS message in the mobile phone 110 (406), requests authorization from the customer (408), and receives the customer's entry with the authorization result. In the case of a positive authorization, the authentication client application 150 requests the customer to choose a payment card, and retrieves the payment card information (412). If the payment card is present, the authentication client application 150 requests a personal identification number (PIN) (416). The customer enters the personal identification number and the authentication client application 150 composes an SMS message with payment card authentication, i.e., payment card number and PIN, and payment authorization (420), performs message encryption (422) and routes the message to the authentication server 107, where it is received as an input for the authentication server application 105. In the cases when the customer does not authorize payment, payment card is not present, or the PIN number is either not entered or is incorrect, the authentication client application 150 sends an error message to the authentication server 107. The authentication client application 150 further provides a user interface to the mobile phone user, i.e., customer, and manages the interactions between the mobile phone and the payment cards.

Referring to FIG. 9H, an authorization and authentication process for a customer initiated payment transaction 500 includes the following steps. The customer shops for goods and/or services at a merchant site (502). The merchant site may be remote or local and the shopping transaction may be non-face-to face or face-to face, respectively. In one example, a non-face-to face shopping for goods at a remote merchant site is shopping for books at the Amazon.com website through the Internet. In another example, the customer interacts with a sales associate of a merchant site via the phone. In yet another example of a non-face-to-face shopping the customer reads a merchant's catalog and fills out a mail order form. In an example of a face-to-face shopping for a service, the customer is hiring a taxi to drive him from his hotel to the airport. After having placed an order, the customer is asked to choose a payment method for the goods and/or services and he chooses to pay with his mobile phone (504). The merchant requests the mobile phone identification information (506). In one example, the mobile phone identification information is the mobile phone number. The customer provides the mobile phone number to the Merchant (508). In one example, the customer types the mobile phone number into a form on the website of the merchant and the information is transmitted to the merchant via the Internet. In another example, the customer interacts with the merchant site via the phone and he enters the mobile phone number using the keypad of the mobile phone or verbally speaking it to the sales associate or to a speech recognition based IVR system. In this example the merchant may also access the mobile phone number via a caller-ID system. The merchant sends a payment request and the mobile phone number to a payment server (510). The payment request includes information about the purchase, i.e., date, time, price, quantity, item code, and delivery date, and information about the identification of the merchant, i.e., store name, store number, and sales associate's name. The payment server routes the payment request and mobile phone number to an authentication server (512). The authentication server sends an SMS message with the payment request via a wireless network to the mobile phone (514). The mobile phone displays the SMS message to the customer (516) and requests authorization for the payment transaction by the customer (518) by selecting “yes” or “no”. If the customer does not authorize the payment transaction, i.e., a “no” selection, an error is displayed on the mobile phone and the customer is asked again to choose a new payment method (520). If the customer authorizes the payment transaction, i.e., a “yes” selection, he is then asked to select a payment card. The customer selects a payment card (522) that is either embedded in the mobile phone or he inserts it in a special slot in the phone. The payment card is a “smart card” i.e., has an embedded IC chip which stores the card number, expiration date, digital signature, information about the financial institution that has issued the card, information about the cardholder and the cardholder's account. In addition to the payment card information, the customer is asked to enter a personal identification number (PIN) to complete the authentication process (524). An authentication client application stored in the mobile phone confirms the validity of the authentication (526). If the authentication is valid the mobile phone routes the payment transaction to the authentication server (530) and the authentication server routes it to the payment server (532). If the authentication is not valid an error is displayed and the customer is asked to select a payment card and repeat the process again (528). The payment server routes the authorized and authenticated payment transaction to the financial institution (534) and the financial institution verifies the availability of funds in the cardholder's account and sends the results to the payment server (536). The payment server routes the results to the merchant server and back to the authentication server (538). The authentication server notifies the customer's mobile phone that the payment transaction has been approved (540) and the merchant delivers the goods and/or services (542). A third party server based authentication method for mobile network operators is described in PCT application WO 00/42792 entitled ‘Apparatus and method relating to authorization control’ the entire content of which is incorporated herein by reference.

What is claimed is:

1. A system for processing a request by a customer to pay a transaction amount, using the customer's account, for a transaction between the customer and a merchant, to provide a payment to an account of the merchant, the transaction incorporating use of a mobile wireless device operated by the customer to provide identification information of the customer's account, the system comprising:
an authentication server configured for communications with the customer's mobile wireless device; and
a payment server coupled to the authentication server, the payment server configured for communications with the merchant and to pass the merchant communications to the authentication server;
wherein the authentication server receives the transaction amount from the merchant and receives customer account information from the customer's wireless mobile device, and processes the transaction and account information and, if authenticated, routes the payment transaction to the payment server for payment to the merchant's account.

2. The system of claim 1 wherein the identification information for the payment card is provided to the mobile wireless device from a contactless smart card at the time of the transaction.

3. The system of claim 1 wherein the identification information for the payment card is provided to the mobile wireless device prior to the transaction.

4. The system of claim 1 for processing the request, wherein the transaction is carried out in the merchant's store.

5. The system of claim 1 for processing the request, wherein the transaction is carried out via the merchant's website.

6. The system of claim 1 involving additional transaction information besides the amount.

7. The system of claim 1 wherein the customer's account is a payment card account.

8. The system of claim 1 wherein the authentication server transmits messages to the mobile wireless device in short message service (SMS) format.
